(19) United States
(12) Patent Application Publication
(10) Pub. No.: US 2003/0190451 A1
(43) Pub. Date: Oct. 9, 2003

(54) Nonwoven interlocking strips and nonwoven industrial fabrics assembled therefrom

(76) Inventors: Samuel M. Baker, Carleton Place (CA); Graham V. Jackson, Carleton Place (CA)

Correspondence Address: Robert A Wilkes, Shapiro Cohen, Station D, PO Box 3440, Ottawa, K1P 6P1, CA

(21) Appl. No.: 10/311,804

(22) PCT Filed: Jun. 19, 2001
(86) PCT No.: PCT/CA01/00911

(51) Int. Cl. B32B 3/06

(52) U.S. Cl. 428/99

(57) ABSTRACT

An industrial fabric comprising at least two separate continuous layers. Each layer includes at least one segment (1) fabricated as a plastics extrusion, such as a strip or panel. The layers are joined by means of cooperating linear interlocking structures (10) located on contiguous planar faces of the segments in the layers. After engagement to form a joint, the cooperating linear interlocking structures provide and maintain a void volume (30) between the layers, and resist compressive loading of the fabric in a more or less predictable manner. The segments may be fabricated from differing thermoplastics so as to impart differing physical properties to each layer. The segments may be porous or non-porous. The industrial fabrics are suitable for use in filtration, membrane, geotechnical and like applications, and find particular utility in continuous filtration applications such as pulp and paper making, sludge dewatering and the like.

### FIELD OF THE INVENTION

This invention relates to nonwoven industrial fabrics which are assembled from a plurality of nonwoven segments, each of which is a plastics extrusion.

### BACKGROUND OF THE INVENTION

Nonwoven industrial fabrics include any sheet product that is manufactured for technical performance and functional properties. Industrial fabrics were generally constructed either by weaving, or by weft insertion warp knitting. An increasing number of these fabrics are now manufactured by other methods, such as:

(1) dry laying of fiber webs by carding or from air streams, followed by bonding into a coherent fabric;

(2) wet laying of fibers by methods akin to paper making;

(3) spun laying or melt blowing by direct extrusion of a molten polymer into a sheet of filaments followed by bonding; and

(4) casting or extrusion of films which are subsequently expanded, slit or perforated, or which are reinforced with yarns.

These nonwoven industrial fabrics are generally suitable for use in applications requiring either a low textile weight(in gm/m²) or a fine pore structure. These fabrics often lack tensile strength and other compensating mechanical properties, but offer other compensating advantages. They also generally lack significant internal void volume, stiffness, and an ability to resist compaction under compressive loading.

It has been proposed by Baker et al. in EP 802,280 to manufacture nonwoven, high strength, industrial fabrics from one or more segments which include integral jointing structures that engage and interlock with each other to join the segments together. Although these fabrics are adequate for use in many applications, they lack resilience and stiffness, and thus cannot adequately accommodate externally imposed stresses, such as compression, out of plane loading, and shear between the layers. Resiliency and stiffness are important properties of an industrial fabric intended for use in applications where fluid is removed by mechanical means, such as by pressing, from a material that is carried upon the fabric. A need therefore exists for a nonwoven industrial fabric having greater resilience, and resistance to compressive loading. Desirably, such a fabric should also be capable of maintaining a void volume between its surface layers while under compression.

The present invention seeks to provide an industrial fabric in which cooperating linear interlocking structures are used to provide a joint between two contiguous faces of at least two adjacent layers, in which each structure is produced as a plastics extrusion. By careful choice of the cooperating linear interlocking structures, it is possible to control the mechanical properties of the fabric in ways that are not possible in known industrial fabrics. Further, the cooperating interlocking structures provide a means whereby opposed edges of the assembled fabric may be joined without necessitating an additional seaming mechanism or manufacturing step, for example by joining opposed longitudinal edges. By means of the present invention, it is now possible to construct an industrial fabric which includes at least two layers wherein the cooperating linear interlocking structures serve to interconnect the layers, to join opposed fabric edges, and to accommodate externally imposed stresses, such as compressive loading, out-of-plane bending, and shear between the layers of the fabric.

By careful choice of both the shape and relative separation of each of the cooperating interlocking structures, which can be the same shape or different shapes, this invention makes it possible to construct a fabric that is capable of resisting compressive loading of the fabric so that void spaces between the layers are maintained, because collapse and expansion of the fabric under cyclic compressive loading occurs in a more or less predictable manner. It is also possible to control various other fabric properties, such as the location of the bending neutral plane within the fabric structures.

The fabrics of this invention therefore find utility in a variety of specialized applications, such as for example, in the press or dryer section of a papermaking machine.

### SUMMARY OF THE INVENTION

In a first broad embodiment, the present invention seeks to provide a nonwoven industrial fabric, including at least a first layer carrying at least one first linear interlocking structure engaged with at least one second linear interlocking structure carried by a second layer, wherein:

(a) the first and the second linear interlocking structures are each located on continuous contiguous faces of the first and the second layer;

(b) the first and the second engaged linear interlocking structures provide a void volume between the two contiguous faces of the two layers;

(c) each layer includes at least one segment carrying the linear interlocking structure, and

(d) the interlocking structures are constructed and arranged to resist compressive loading after engagement.

In a second broad embodiment this invention also seeks to provide a segment for use in the assembly of an industrial fabric, the segment having a predetermined length, width and thickness, wherein:

(i) at least a first generally planar face of the segment includes at least one linear interlocking structure;

(ii) the segment is a plastics extrusion; and

(iii) the at least one interlocking structure is constructed and arranged to resist compressive loading after engagement.

Preferably, within each layer the or each segment includes a plurality of substantially parallel linear interlocking structures.

Preferably, within each layer the segment or segments are chosen from the group consisting of a strip and a panel.

Preferably, within each layer the segments are located in an abutting relationship to the adjacent segment or segments.

Preferably, the interlocking structures are located in a predetermined regular pattern on each of the contiguous continuous faces.

Preferably, the first and the second interlocking structures are the same. Alternatively, the first and the second interlocking structures are either not the same, or the second interlocking structure is a mirror image of the first interlocking structure.

Preferably, engagement of the cooperating interlocking structures is irreversible, and the structures cannot be disengaged after assembly, without the risk of significant damage to the linear interlocking structures. Alternatively, engagement of the cooperating interlocking structures is reversible, and the structures can be disengaged after assembly, without the risk of damage to the linear interlocking structures.

Preferably, the segments are fabricated from a material selected from the group consisting of: polyamides; copolyamides; polyesters; copolyesters; polyolefins; polyketones and polyarylene sulfides.

Preferably, a polyamide is chosen from the group consisting of polyamide 6, 4/6, 6/6, 6/10 and 6/12.

Preferably a polyester is chosen from the group consisting of polyethylene terephthalate (PET), polybutylene terephthalate (PBT), polypropylene terephthalate (PPT), polytrimethylene terephthalate (PTMT), polyethylene naphthalate (PEN), and poly(cyclohexylene dimethylene terephthalate) (PCT).

Preferably the copolyester is poly(cyclohexylene dimethylene terephthalate) acid modified (PCTA).

Preferably, the polyolefin is polypropylene.

Preferably, a polyketone is chosen from the group consisting of polyetherketone (PEK) and polyetheretherketone (PEEK).

Preferably, the polyarylene sulfide is polyphenylene sulfide (PPS).

The selection of an appropriate polymer for use in the production of the segments will be indicated by the end use for the industrial fabric, bearing in mind both the environment of use and the mechanical loads to be placed upon the fabric.

Preferably, in each of the layers all of the segments are fabricated from the same polymer. Alternatively, in each layer the segments are fabricated from different polymers. Preferably, where the segments in a layer are fabricated from different polymers, each of the polymers is chosen to suit the intended use of the fabric, with particular attention to the environmental conditions to which each layer will be exposed.

Preferably, the cooperating interlocking structures are engaged by snap or press fitting the cooperating linear interlocking structures together. Alternately, the cooperating interlocking structures are engaged by sliding the cooperating interlocking structures together.

Conveniently, at least one of the layers may also include non-cooperating interlocking structures, such as spike or hook members, on a third noncontiguous face that is adapted for the attachment of another layer, such as a fibrous batt or other nonwoven assembly of fibers or foam. This concept is disclosed by Baker in EP 802 280.

The dimensions of the segments from which the industrial fabrics of this invention are assembled are selected in accordance with the end use requirements of the fabric.

In a further embodiment of this invention, the segments may be porous or nonporous. If the segments are required to be nonporous, then no further processing should be required. If the strips or panels are required to be porous it is preferred that they be rendered porous prior to their assembly into an assembled industrial fabric, for example by perforation or other appropriate technique which causes minimum damage to the interlocking structures. The fabrics of this invention may also be made porous after assembly of the segments by suitable means such as laser or ultrasonic drilling. In using such processes care must be taken to minimize if not completely prevent damage to the interlocking structures.

Preferably, in a segment that has been rendered porous, the porosity provides a total open area of from about 30% to about 60% of the total surface area of the segment. More preferably, the porosity is from about 35% to about 55%. Most preferably the porosity is from about 40% to about 50%. The size, shape and location of the pores will be chosen to suit the intended end use of the fabric.

The segments are assembled into a fabric with the jointing structures in any suitable direction bearing in mind the intended end use, and bearing in mind that these structures impart a level of beam stiffness to the fabric along their length direction. If the fabric is intended to be assembled as a loop, at the joint the segment ends in each layer can be offset, so that the segments in each layer overlap and the jointing structures are used to close the loop, thus eliminating the need for a separate seam structure. An offset joint can thus be made with the linear jointing structures oriented either parallel or perpendicular to the line of the joint. The orientation will be chosen in light of the end use for the fabric. An offset joint also facilitates installation of the fabric for use, since the fabric can be manufactured to the required length and closed to a loop when installed. The amount of overlap is chosen to suit the conditions of use of the fabric, particularly any imposed tensile stresses.

### BRIEF DESCRIPTION OF THE DRAWINGS

The invention will now be described in further detail in relation to attached Figures which illustrate cross sections of linear cooperating interlocking structures attached to suitable segments.

FIGS. 1-10 and 19 show cooperating interlocking structures which can be joined by sliding insertion of one structure into the other and in which the interlocking structures are substantially the same; and

FIGS. 11-18 show pairs of cooperating interlocking structures which may be joined either by sliding insertion or by snap fitting in which the interlocking structures are significantly different.

In several of these Figures the interlocking structures are shown both engaged and disengaged.

### DETAILED DESCRIPTION OF THE DRAWINGS

In these Figures, a segment 1, which may be a strip or a panel, carries a linear interlocking structure 10 on a generally planar base layer 13. A segment 2, which also may be a strip or a panel, carries either the same interlocking structure 10, or a second different linear interlocking structure 20. The segments 1 and 2 and the associated interlocking structures are formed by extrusion of a suitable thermoplastic material. The interlocking structure 10 includes a support 11, and optionally a latching means 12, depending on the shape of the interlocking structure 10 which may be desirable to engage securely two of the interlocking structures together. Similarly, the interlocking structure 20 includes a support 21 and optionally a latching means 22. After engagement of the interlocking structures a void volume 30 is provided between two opposed segments.

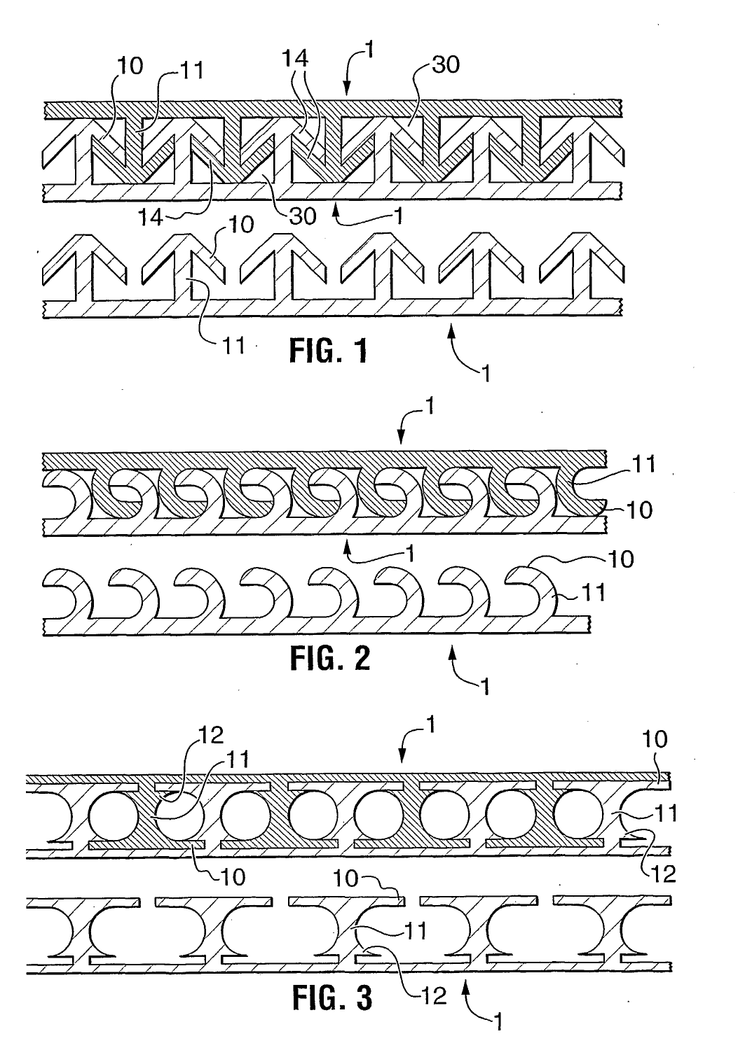

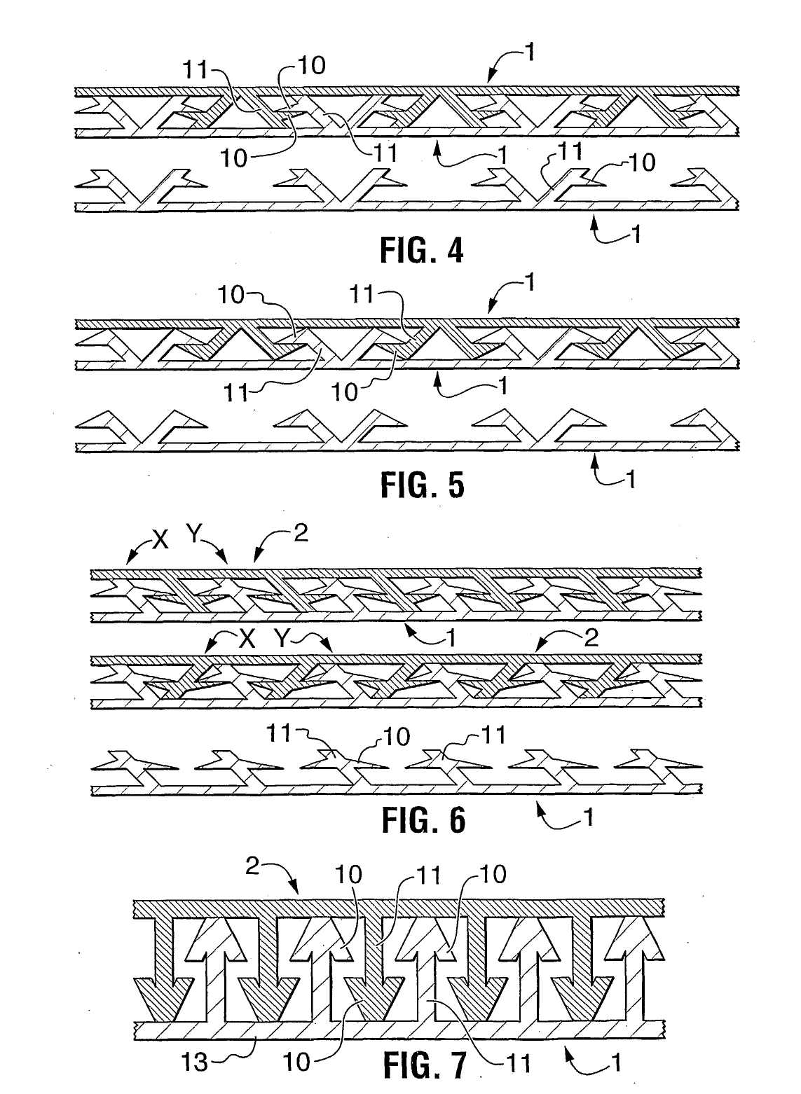

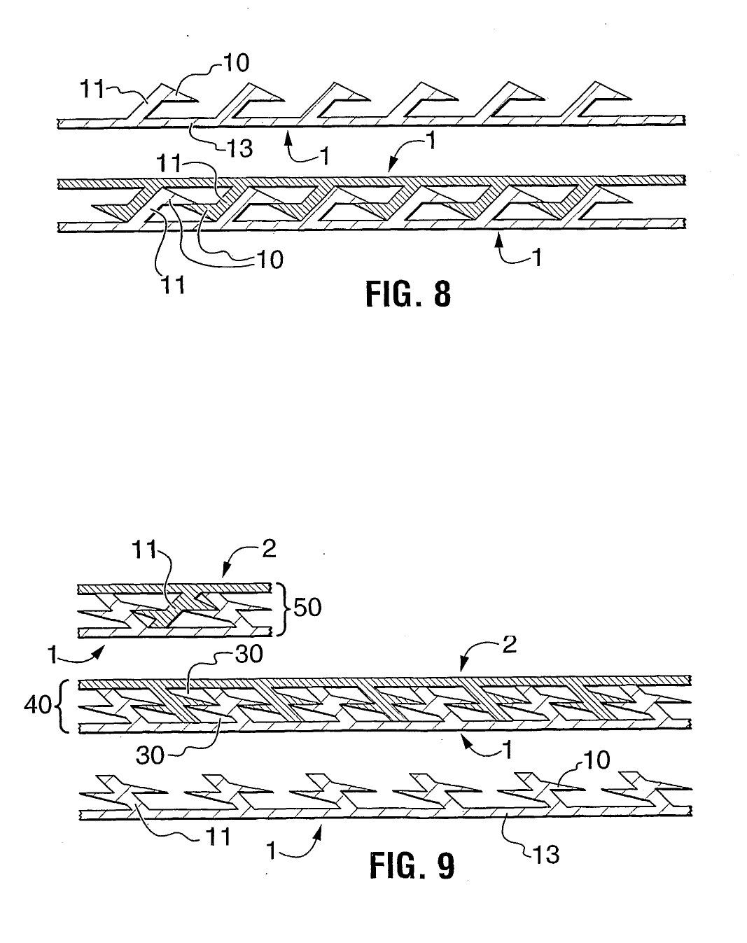

FIGS. 1-10 and 19 illustrate cross sections of a first group of linear interlocking structures. In each of these Figures, the same interlocking structure is engageable with itself to provide the required joint. All of these structures can be engaged by sliding insertion of one of a pair of structures into the other; some of them can also be snap fitted together.

FIG. 1 is exemplary of this group; it cannot be snap fitted together. FIG. 1 shows segment 1 carrying a linear interlocking structure 10, having a support 11 located on a generally planar base layer 13. When assembled by rapier insertion, a void volume 30 is formed between the segments, on an axis substantially vertical to the plane of the Figure. Each support 11 buttresses adjacent supports 11 so as to maintain the void volume 30 under compressive loading of the fabric by resisting collapse of the structures 10. In FIG. 1 it can also be seen that the angled parts 14 of the structure 10 both aid in resisting compression, and also improve the beam stiffness of the joint along a line in the plane of the Figure.

FIGS. 6, 9 and 19 show two further features of this invention. In FIG. 6, two arrangements are shown. In each of them the segment 1, or both segments 1 and 2, carry the same interlocking structure 10 on a support 11. Segment 2 can then be either the same as segment 1, to provide the jointed structure 40, or segment 2 can be a mirror image of segment 1, to provide the jointed structure 50. FIG. 9 takes this concept a step further. The jointed structure 41 uses two segments which are the same as segment 1. However it is possible to alter the angle of the support 22 to the location shown in the jointed structure 50. As the interlocking structures 10 are asymmetrical, the segments 1 and 2 in the structure 50 are not mirror images of each other. In FIG. 19 the same approach is used, again by altering the angle of the support 11 to the base layer 13. By altering the angle of the support 11 in FIGS. 9 and 19 the manner in which the fabric resists compressive loading is changed. In one case, the engaged linear jointing structures from essentially a Warren truss structure which will resist compression so as to maintain the void volume 30 between the two segments. In the other case, the structures 10 will all collapse in the same direction, and retention of the void volume 30 will depend on the direction of the compressive load on the fabric. Thus although the two arrangements 60 and 70 in FIG. 19 look similar, the interlocking structure 20 together with its support 21 is not a mirror image of the interlocking structure 10 and its support 11, and the manner in which the fabric will collapse is not the same. This is also the case for the structure shown n FIG. 9.

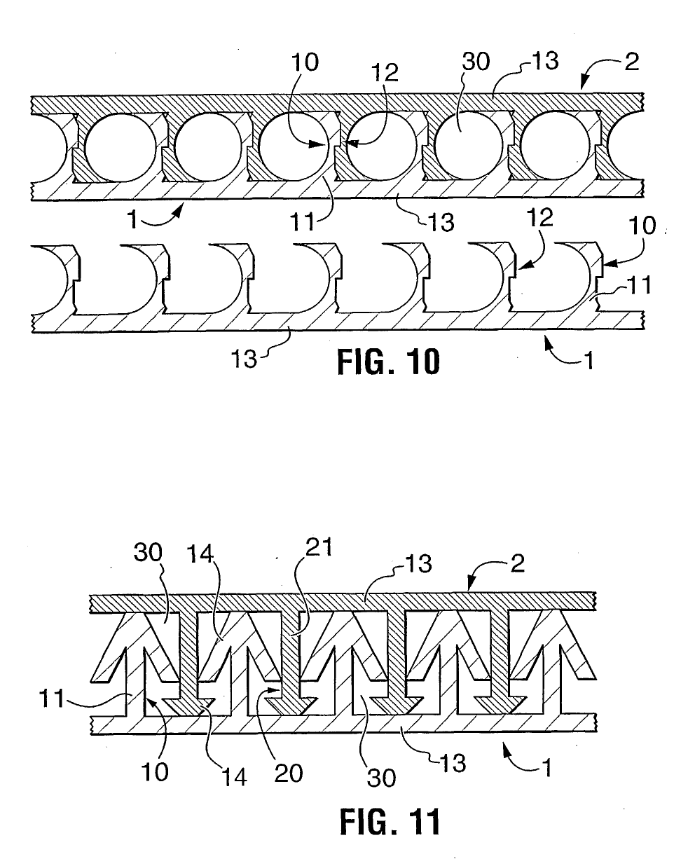

FIG. 10 shows a further feature of this invention. The segment 1 carries a jointing structure 10 carried by a support 11 on a generally planar base 13. The two interlocking structures can be engaged together either by sliding or by a snap fit. In this structure, the support 11 includes cooperating latching members 12 which engage with each other as the joint is closed to improve its integrity.

Inspection of FIGS. 1 and 3 shows that disengagement of the two segments can only be done without the risk of significant damage to the interlocking structures by sliding them apart. A similar risk will exist for latched structures, such as that shown in FIG. 10. In contrast, inspection of FIGS. 2 and 5 shows that disengagement of the two segments does not imply significant damage to the jointing structures.

It will be apparent from these and the remaining Figures that the linear interlocking structures create the void volume 30 between the segments used in the fabric. The manner in which the engaged interlocking structures resist compressive loading will be determined by the cross sectional shape of the engaged joint, and the size and location of the internal spaces making up the void volume. These are chosen to provide a fabric with the desired properties. The engaged linear jointing structures also impart stiffness to the assembled fabric, similar to that obtained from an “I” beam or truss arrangement. The fabric flexibility along the linear joint can thus be quite different to the fabric flexibility in a direction perpendicular to the linear joint. Because the cooperating interlocking structures are not adhesively bonded into place, the two jointed segments are capable of sliding somewhat relative to each other, which improves the ability of the fabric to resist imposed stresses. Thus, when the strips or panels are oriented in the longitudinal direction (that is towards the length of the assembled fabric), each may shift to a small degree relative to the other. Such relative movement will be useful in continuous process applications requiring the fabric to bend about drive or turning rolls.

Within this group of Figures, the structures shown in FIGS. 2, 3, 10, and 11 can also be engaged by snap or press fitting. The latching means 12 shown in FIG. 11 can be dimensioned and structured such that snap or press fit engagement is possible.

FIG. 2 is exemplary. In FIG. 2 the segment I carries a linear interlocking structure 10 on a support attached to a generally planar base layer 13. The clearances of the arrow head shape for the structure 10 permit the two segments to be pressed into engagement. This Figure also shows a further feature of this invention. The clearances around the arrow head shapes will allow some level of movement of the engaged segments relative to each other, including the ability to separate as far as the engaged structures 10 will allow, thus altering the void volume to some extent.

Alternatively, the complementary interlocking structures may be engaged together by bending the segment over a radius perpendicular to the direction of the linear interlocking structures so as to increase the size of the opening between each of the structures 10, thereby allowing a second set of structures to be pushed into engagement. This may be done in a relatively simple manner by bending either one or both segments over a curved “shoe”.

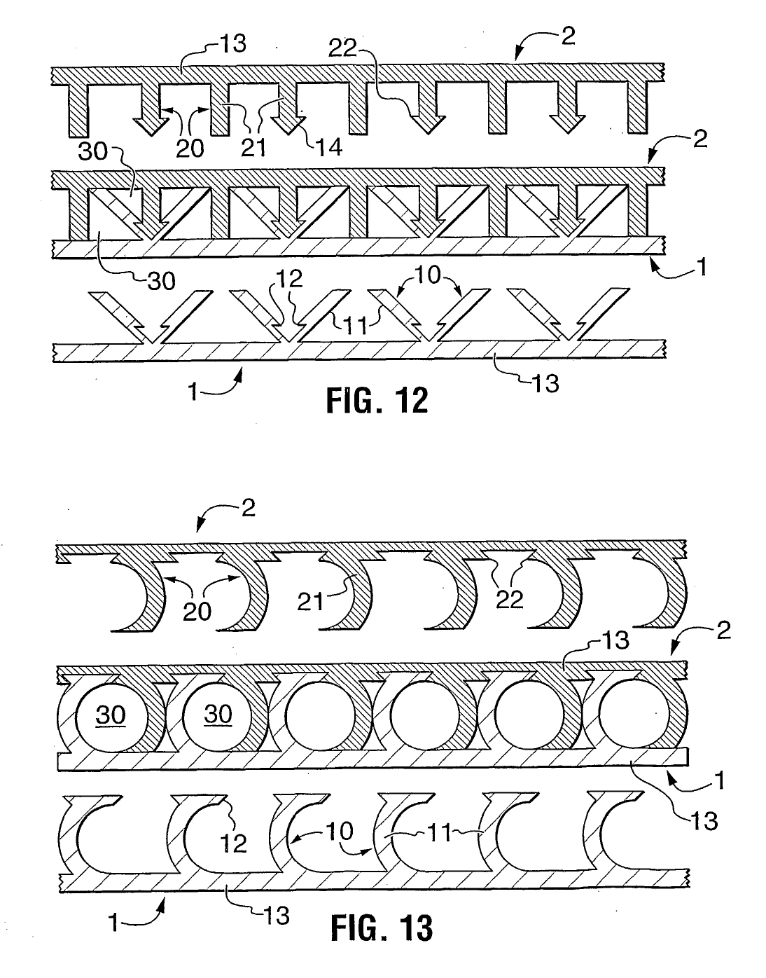

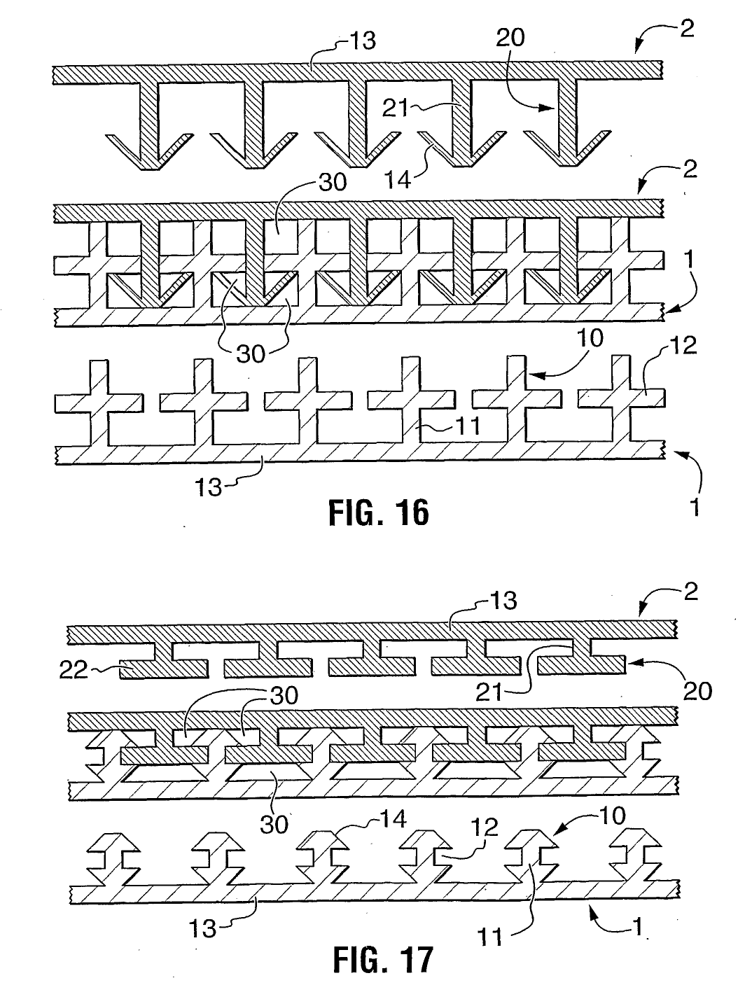

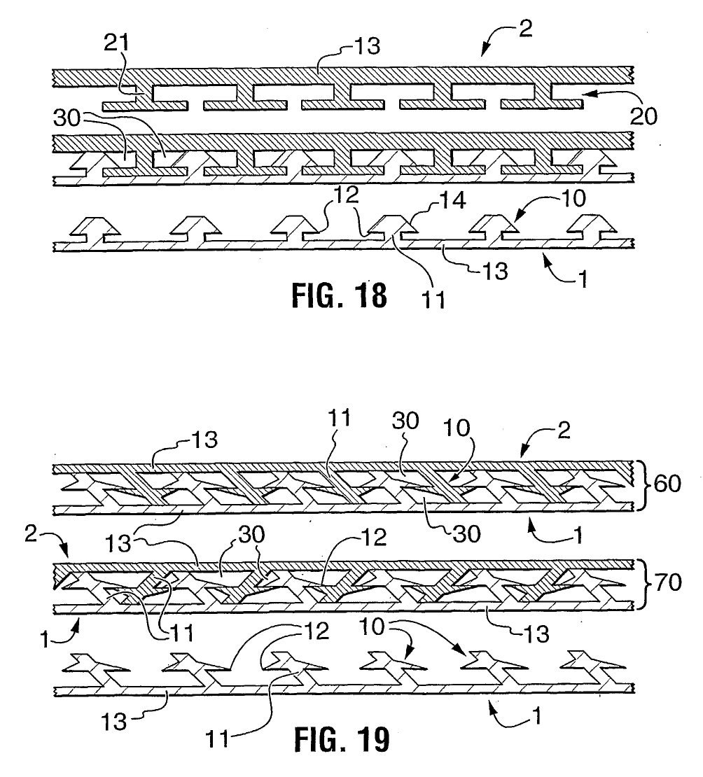

FIGS. 10-18 illustrate cross sections of a second group of linear interlocking structures. In each of these Figures, two different interlocking structures are engaged to provide the required joint, several of which include latching structures. These are all engaged either by sliding insertion or by snap fitting the two structures together as appropriate.

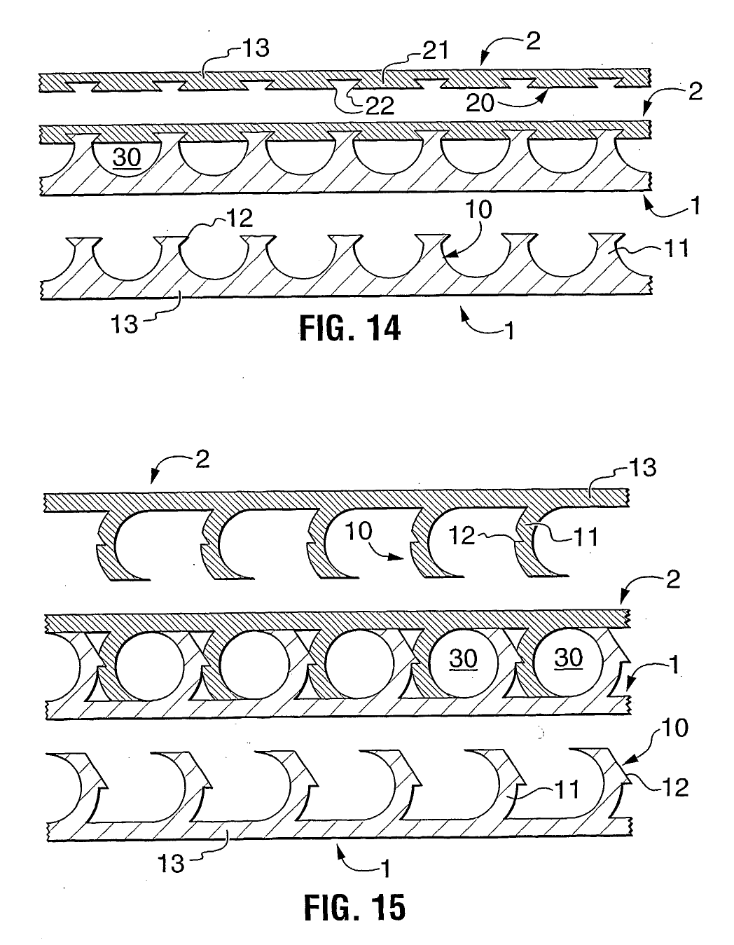

These Figures show a further feature of this invention. Comparison of, for example FIGS. 14, 15 and 16 shows that the cross sections of two structures making up the engaged joint are very dissimilar. Since the location of the neutral bending plane of the engaged joint depends on the nature of the linear jointing structures, the interlocking structure shapes in combination in addition to being chosen to resist compressive load, can also be chosen to locate the neutral plane nearer to one surface of the fabric. The ability to achieve this is important in some applications, for example when the fabric is used to carry a paper web: location of the neutral plane near to the paper web reduces stresses imposed on the paper web as the paper web and fabric are wrapped about carrying rollers.

A further feature of this invention can also be seen from a comparison of the two engaged structures 40 and 50 in FIG. 6. In the engaged structure 40 all of the supports 11 are essentially parallel, and hence under compressive load the engaged linear jointing structures will collapse more easily in the direction of the arrow X than in the direction of the arrow Y. In contrast, in the engaged structure 50, the supports are not parallel, and form a truss-like arrangement, so that the engaged structure will resist compressive loads more or less the same in the directions of both arrows X and Y.

We claim:

1. 1. A non-woven industrial fabric, including at least a first layer carrying at least one first linear interlocking structure engaged with at least one second linear interlocking structure carried by a second layer, wherein:
(a) the first and the second linear interlocking structures are each located on continuous contiguous faces of the first and the second layer;
(b) the first and the second engaged linear interlocking structures provide a void volume between the two contiguous faces of the two layers
(c) each layer includes at least one segment carrying the linear interlocking structure; and
(d) the interlocking structures are constructed and arranged to resist compressive loading after engagement.

2. A segment for use in the assembly of an industrial fabric, the segment having a predetermined length, width and thickness, wherein:
(i) at least a first generally planar face of the segment includes at least one linear interlocking structure;
(ii) the segment is a plastic extrusion; and
(iii) the at least one interlocking structure is constructed and arranged to resist compressive loading after engagement.

3. A fabric according to claim 1 wherein within each layer the or each segment includes a plurality of substantially parallel linear interlocking structures.

4. A fabric according to claim 1 wherein within each layer the segment or segments are chosen from the group consisting of a strip and a panel.

5. A fabric according to claim 1 wherein within each layer the segments are located in an abutting relationship to the adjacent segment or segments.

6. A fabric according to claim 1 wherein the interlocking structures are located in a predetermined regular pattern on each of the contiguous continuous faces.

7. A segment according to claim 2 wherein the interlocking structures are located in a predetermined regular pattern on each of the contiguous continuous faces.

8. A fabric according to claim 1 wherein the first and the second interlocking structures are the same.

9. A segment according to claim 2 wherein the first and the seond interlocking structures are the same.

10. A fabric according to claim 1 wherein the first and the second interlocking structures are either not the same, or the second interlocking structure is a mirror image of the first interlocking structure.

11. A segment according to claim 2 wherein the first and the second interlocking structures are either not the same, or the second interlocking structure is a mirror image of the first interlocking structure.

12. A fabric according to claim 1 wherein engagement of the cooperating interlocking structures is irreversible, and the layers cannot be disengaged after assembly.

13. A fabric according to claim 1 wherein engagement of the cooperating interlocking structures is releasable.

14. A fabric according to claim 1 wherein the segments are fabricated from a material selected from the group consisting of: polyamides; copolyamides; polyesters; copolyesters; polyolefins; polyketones and polyarylene sulfides.

15. A segment according to claim 2 fabricated from a material selected from the group consisting of: polyamides; copolyamides; polyesters; copolyesters; polyolefins; polyketones and polyarylene sulfides.

16. A fabric according to claim 14 wherein the segments are fabricated from a polyamide chosen from the group consisting of polyamide 6, 4/6, 6/6, 6/10 and 6/12.

17. A fabric according to claim 14 wherein the segments are fabricated from a polyester chosen from the group consisting of polyethylene terephthalate (PET), polybutylene terephthalate (PBT), polypropylene terephthalate (PPT), polytrimethylene terephthalate (PTMT), polyethylene naphthalate (PEN), and poly(cyclohexylene dimethylene terephthalate) (PCT).

18. A fabric according to claim 14 wherein the segments are fabricated from the copolyester poly(cyclohexylene dimethylene terephthalate) acid modified (PCTA).

19. A fabric according to claim 14 wherein the segments are fabricated from the polyolefin polypropylene.

20. A fabric according to claim 14 wherein the segments are fabricated from a polyketones chosen from the group consisting of polyetherketone (PEK) and polyetheretherketone (PEEK).

21. A fabric according to claim 16 wherein the segments are fabricated from the polyarylene sulfide polyphenylene sulfide (PPS).

22. A fabric according to claim 1 wherein in each of the layers all of the segments are fabricated from the same polymer.

23. A fabric according to claim 1 wherein in each layer the segments are fabricated from different polymers.

24. A fabric according to claim 1 wherein the segments are porous or nonporous.

25. A fabric according to claim 24 wherein the porosity provides a total open area of from about 30% to about 60% of the total surface area of the segment.

26. A fabric according to claim 24 wherein the porosity provides a total open area of from about 35% to about 55% of the total surface area of the segment.

27. A fabric according to claim 24 wherein the porosity provides a total open area of from about 40% to about 50% of the total surface area of the segment.
